(19) United States
(12) Patent Application Publication
(10) Pub. No.: US 2026/0044940 A1
(43) Pub. Date: Feb. 12, 2026

(54) SYSTEM FOR PROCESSING IMAGES ACQUIRED BY AN AIR VEHICLE

(71) Applicants: OZYEGIN UNIVERSITESI, Istanbul (TR); ISTANBUL TEKNIK UNIVERSITESI BILIMSEL ARASTIRMA PROJE BIRIM, Istanbul (TR)

(72) Inventors: Sedat OZER, Istanbul (TR); Hakan Ali CIRPAN, Istanbul (TR); Huseyin Enes ILHAN, Izmir (TR)

(73) Assignees: OZYEGIN UNIVERSITESI, Istanbul (TR); ISTANBUL TEKNIK UNIVERSITESI BILIMSEL ARASTIRMA PROJE BIRIM, Istanbul (TR)

(21) Appl. No.: 18/998,148

(22) PCT Filed: Aug. 31, 2022
(86) PCT No.: PCT/TR2022/050926

§ 371 Date: Jan. 24, 2025

(30) Foreign Application Priority Data
Jul. 25, 2022 (TR) 2022/011774

(51) Int. Cl. G06T 5/70; G06T 7/10

(52) U.S. Cl. CPC G06T 5/70; G06T 7/10; G06T 2207/10032; G06T 2207/20032; G06T 2207/20081; G06T 2207/20084

(57) ABSTRACT

A system includes an air vehicle having an image sensor to acquire images, a control unit to process images acquired by the image sensor, and a communication unit to transmit images processed by the control unit to a remote server by at least one base station. Accordingly, the control unit is configured to modulate the acquired images and send them to the base station by the communication unit; the base station is configured to demodulate the images coming from the air vehicle and to transmit the received images to the server; the server includes a memory unit containing a pre-trained deep learning model to process the images and a processor unit configured to process the images coming from the air vehicle through the deep learning model in the memory unit; the processor unit is configured to perform a noise removal process to reduce the noise.

### CROSS REFERENCE TO THE RELATED APPLICATIONS

This application is the national phase entry of International Application No. PCT/TR2022/050926, filed on Aug. 31, 2022, which is based upon and claims priority to Turkish Patent Application No. 2022/011774, filed on Jul. 25, 2022, the entire contents of which are incorporated herein by reference.

### TECHNICAL FIELD

The invention relates to a system and method for processing images acquired by an air vehicle.

### BACKGROUND

Image and video analysis in unmanned air vehicle (UAV) systems has recently drawn attention in many applications since the images and videos acquired by UAV systems can be useful in many areas such as maintenance, surveillance, and entertainment. One constraint on UAVs is that they have limited battery power and recent developments in the field of artificial intelligence (AI) encourage many computationally heavy applications on the acquired UAV images.

Unmanned Air Vehicles (UAVs) having cameras are used in many areas such as entertainment, surveillance, rescue and maintenance. Most of these areas have applications requiring vision based algorithms including tracking, detection, or segmentation tasks. Today's state-of-the-art tracking, detection, or segmentation algorithms use deep learning-based techniques, and these techniques typically require intensive computation, large memory, and large power supplies. However, one of the typical bottlenecks in the use of UAVs is the limited battery power of UAVs and therefore, the use of computationally heavy applications running on the UAV boards is not desirable. Such a bottleneck causes researchers to develop various discharging techniques. Such discharging techniques enable object tracking, object detection, or object segmentation to be used on the air vehicle without requiring heavy computational resources on the UAV's board by first subjecting the images to processes with lower computation density with processes such as image processing, filtering, coding, etc. Then, the images obtained as a result of these processes are transferred to a remote server by a base station. Thus, the image, in which the object monitoring, object detection, or object segmentation is performed, is transmitted to a server away from the air vehicle.

As a result, all issues mentioned above made it necessary to make an innovation in the relevant technical field.

### SUMMARY

The present invention relates to a system and method to eliminate the above-mentioned disadvantages and bring new advantages to the relevant technical field.

An object of the invention is to provide a system and method for reducing the energy and computational requirements of the air vehicle.

Another object of the invention is to provide a system and method for performing object tracking, object detection, or object segmentation on an image acquired by an air vehicle by using existing state of the art algorithms without requiring strong processors on the AUV's board.

The present invention relates to a system including an air vehicle having an image sensor to acquire images, a control unit to process images acquired by the image sensor, and a communication unit to transmit images processed by the control unit to a remote server by at least one base station to realize all the objects that are mentioned above and will emerge from the following detailed description. Accordingly, the control unit is configured to modulate the acquired images and send them to the remote base station via the communication unit; the base station is configured to demodulate the image signals coming from the air vehicle and to transmit the received images to the said server; the server includes a memory unit containing a pre-trained deep learning model to process the images and a processor unit configured to process the images coming from the air vehicle through the deep learning model in the said memory unit; the said processor unit is configured to perform a noise removal process to reduce the noise generated during the transfer of the images to the base station before processing the images acquired by the air vehicle. Thus, the images acquired by the air vehicle are processed on a remote server. There is no need to train algorithms such as machine learning or deep learning models on the air vehicle. In this way, the system requirements of the air vehicle are reduced. In addition, the power and processor capacity required by the air vehicle is reduced. In this way, the cost of the air vehicle is reduced. A noise signal will be generated in the images transferred wirelessly from the air vehicle to the base station. Performing noise removal to reduce the noise that occurs during the transfer of images to the base station through the processor unit increases the output accuracy of the artificial intelligence, machine learning, or deep learning model to run on the server.

A possible embodiment of the invention is characterized in that the said server includes a memory unit containing a pre-trained deep learning model to segment images and a processor unit configured to segment images coming from the air vehicle through the deep learning model in the said memory unit; the said processor unit is configured to perform a noise removal process to reduce the noise generated during the transfer of images to the base station before segmenting images acquired by the air vehicle.

Another possible embodiment of the invention is characterized in that the said server includes a memory unit containing a pre-trained deep learning model to detect at least one object in the image and a processor unit configured to detect at least one object in the images coming from the air vehicle through the deep learning model in the said memory unit; the said processor unit is configured to perform a noise removal process to reduce the noise generated during the transfer of the images to the base station before detecting an object in the images acquired by the air vehicle.

Another possible embodiment of the invention is characterized in that the said control unit is configured to convert the acquired images into binary vectors. Thus, it is ensured that the size of the image is digitally reduced. In addition, the mathematical operation is facilitated on the image.

Another possible embodiment of the invention is characterized in that the said processor unit is configured to perform median filtering in the said noise removal process. Thus, the noise generated during the transfer of the images to the base station is reduced.

Another possible embodiment of the invention is characterized in that the said processor unit is configured to perform average filtering in the said noise removal process. Thus, the noise generated during the transfer of the images to the base station is reduced.

Another possible embodiment of the invention is characterized in that the said processor unit is configured to perform block-matching and three-dimensional filtering in the said noise removal process. Thus, the noise generated during the transfer of the images to the base station is reduced.

Another possible embodiment of the invention is characterized in that the said processor unit is configured to perform the said noise removal process with an artificial intelligence (AI) based deep learning model. The said deep learning model is trained with the PASCAL and ImageNet visual object classes dataset.

Another possible embodiment of the invention is characterized in that the said communication unit is a Long Term Evolution (LTE) module; it is configured to demodulate the images acquired by the said base station under LTE standards. Thus, communication is ensured under LTE communication standards.

Another possible embodiment of the invention is characterized in that the said communication unit is a 5G module; it is configured to demodulate the images acquired by the said base station under 5G standards. Thus, it is ensured that the system communicates under 5G communication standards.

Another possible embodiment of the invention is characterized in that the said communication unit is a 6G module; it is configured to demodulate the images acquired by the said base station under 6G standards. Thus, it is ensured that the system communicates under 6G communication standards.

Another possible embodiment of the invention is characterized in that the said air vehicle is an unmanned air vehicle.

Another possible embodiment of the invention is characterized in that the said unmanned air vehicle is configured to have remote flight control.

Another possible embodiment of the invention is characterized in that the said unmanned air vehicle is configured to fly along the predetermined route.

Another possible embodiment of the invention is characterized in that the said unmanned air vehicle is configured to fly autonomously.

Another possible embodiment of the invention is characterized in that the said image sensor is the camera in such a way that each pixel color is a separate value and it takes a color image recorded with 8 bits for each channel.

Another possible embodiment of the invention is characterized in that it includes a power unit positioned on the air vehicle to supply electrical energy to the said air vehicle.

Another possible embodiment of the invention is characterized in that the base station (110) is configured to demodulate images coming from the air vehicle and to transmit the received images to the said server (120) through a cable. Thus, the wired transmission between the base station and the server enables the image coming to the base station to be transmitted to the server without modulation. In this way, it is ensured that noises that may arise from wireless communication between the server and the base station are prevented.

The invention also relates to a method for processing images acquired by an air vehicle having an image sensor to acquire images, a control unit to process images acquired by the image sensor.

According to this, it is characterized in that it includes the following steps:
acquiring images through the image sensor,
modulating the acquired image by the said control unit for wireless transmission thereof,
transmitting the modulated image to a base station by a communication unit,
demodulating the image transmitted to the said base station,
transmitting the demodulated image to a server through a cable,
performing a noise removal process to reduce the noise generated during the transmission of images to the base station by a processor unit of the said server,
processing the image in which the noise removal process is performed through a pre-trained deep learning model in a memory unit of the server.

Thus, multiple artificial intelligence, machine learning, or deep learning models are enabled to run on a remote server instead of an air vehicle. In this way, the system requirements of the air vehicle are reduced.

Another possible embodiment of the invention is characterized in that it includes the process step of segmenting the image in which the noise removal process is performed through a pre-trained deep learning model in the said memory unit.

Another possible embodiment of the invention is characterized in that it includes the process step of detecting at least one object in the image in which the noise removal process is performed through a pre-trained deep learning model in the said memory unit.

Another possible embodiment of the invention includes the process step of converting the image into a binary vector by the image sensor.

Another possible embodiment of the invention is characterized in that the said noise removal process includes a median filtering process.

Another possible embodiment of the invention is characterized in that the said noise removal process includes an average filtering process.

Another possible embodiment of the invention is characterized in that the said noise removal process includes a block-matching and three-dimensional filtering process.

Another possible embodiment of the invention is characterized in that the said deep learning model is trained with the PASCAL and ImageNet visual object classes dataset.

### BRIEF DESCRIPTION OF THE DRAWINGS

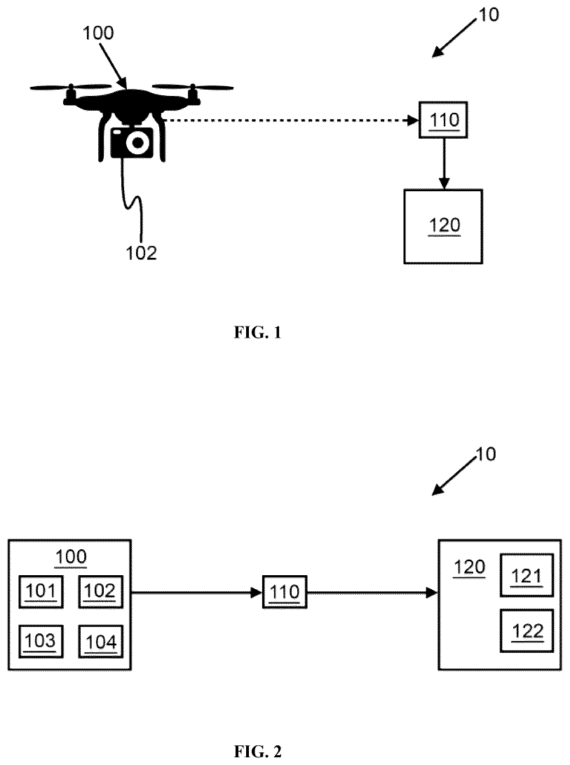

A representative view of the system is given in FIG. 1.

A representative view of the system components is given in FIG. 2.

### REFERENCE NUMBERS IN THE FIGURES

10 System
100 Air vehicle
101 Control unit
102 Image sensor
103 Communication unit
104 Power unit
110 Base station
120 Server
121 Processor unit
122 Memory unit

### DETAILED DESCRIPTION OF THE EMBODIMENTS

The system and method of the invention are explained with examples that do not have any limiting effect only for a better understanding of the subject in this detailed description.

The invention relates to a system (10) for processing images acquired by an air vehicle (100). The said air vehicle (100) is preferably an unmanned air vehicle (100). The unmanned air vehicle (100) may also be an air vehicle (100) that is remotely controlled or flies on a predetermined route. The said system (10) enables the deep learning-based processes to be performed on the images acquired by the air vehicle (100) on a remote server (120). In this way, the system requirements of the air vehicle (100) such as the processor and the battery are reduced.

The air vehicle (100) includes an image sensor (102) to acquire images. The said image sensor (102) is a camera such that each pixel color is a separate value and it takes a color image recorded with 8 bits for each channel. The air vehicle (100) includes a control unit (101) to process images acquired by the image sensor (102). The said control unit (101) converts the images acquired by the image sensor (102) into binary vectors. The said binary vector is an image processing technique known in the art. The air vehicle (100) includes a communication unit (103) to transmit the images processed by the control unit (101) to a remote server (120) by at least one base station (110). The control unit (101) modulates the acquired images to send them through the communication unit (103). The said modulation process is carried out according to the communication protocol of the communication unit (103) and the base station (110). The base station (110) demodulates images coming from the air vehicle (100). The communication unit (103) is an LTE module in a possible embodiment. In this embodiment, the said base station (110) is configured to demodulate the acquired images under LTE standards. The communication unit (103) is a 5G module in another possible embodiment. In this embodiment, the base station (110) is configured to demodulate the acquired images under 5G standards. In the possible embodiment of the invention, the communication unit (103) may be any wireless communication module.

The base station (110) is configured to demodulate the images acquired from the air vehicle (100) and to transmit the received images to the said server (120) through a cable. The server (120) includes a memory unit (122) containing a pre-trained deep learning model for processing images. The server (120) includes a memory unit (122) containing a pre-trained deep learning model for segmenting images in a possible embodiment. In another possible embodiment, the server (120) includes a memory unit (122) containing a pre-trained deep learning model for detecting at least one object in the images. The server (120) also includes a processor unit (121) configured to process images coming from the air vehicle (100) through the deep learning model in the said memory unit (122). The said processor unit (121) is configured to perform a noise removal process to reduce the noise generated during the transfer of the images to the base station (110) before processing the images acquired by the air vehicle (100). The said noise removal process reduces the distortion signals that occur during the transmission of images through the wireless communication channel. The said pre-trained deep learning model segments the image in a possible embodiment. In another possible embodiment, the pre-trained deep learning model detects at least one object in the image. Dividing the image into segments is also known in the art as image segmentation. The object recognition in the image is also known in the art as object detection. The said deep learning model is trained with predefined multiple image data. The deep learning model is preferably trained with the PASCAL visual object classes dataset. PASCAL visual object classes provide standardized image datasets for object class detection known in the art.

The processor unit (121) is configured to perform median filtering in the said noise removal process in a possible embodiment of the invention. The median filter is a filter to reduce noise in the picture, which calculates the value of each known pixel in the art according to neighboring pixel values in its vicinity. In the median filter, the pixel value is determined by enumerating the neighboring pixels and taking the value in the middle of the order. If the examined region (inside the template) has an even number of pixels, the average of the two pixels in the middle is used as the middle value. The processor unit (121) is configured to perform average filtering in the said noise removal process in a possible embodiment of the invention. The average filter is to replace each pixel value of an image with the average value that includes its neighbors and itself. This leads to the elimination of pixel values that do not represent those around them. Thus, it is to reduce the amount of replacement between one pixel and the other. The average filter is a filter used to reduce noise in images known in the art. The processor unit (121) is configured to perform block-matching and three-dimensional filtering in the said noise removal process in a possible embodiment of the invention. The said block-matching and three-dimensional filtering is a filtering process to reduce noise in the image known in the art.

The invention also relates to a method for processing images acquired by the air vehicle (100). The said method enables the processing of the images acquired by the air vehicle (100) on a remote server (120). In this way, the system requirements of the air vehicle (100) are reduced. The method allows for reducing the noise generated during the transfer of images from the air vehicle (100) to the server (120). In this way, the output accuracy of artificial intelligence, machine learning, or deep learning models to run on the remote server (120) is increased. The said artificial intelligence, machine learning, or deep learning models are highly sensitive to signal noises.

The method includes the step of acquiring images by the image sensor (102). The acquired image is converted to a binary vector. Thus, it is ensured that the size of the image is digitally reduced. In addition, the mathematical operation is facilitated on the image. The binary vector image is modulated for wireless transmission by the control unit (101). The thus modulated image is transmitted to a base station (110) by a communication unit (103). The image transmitted to the base station (110) is demodulated. Thus, the image acquired by the air vehicle (100) is obtained again. The demodulated image is transmitted to a server (120) through a cable. The conductive cable provided between the base station (110) and the server (120) enables the image acquired from the air vehicle (100) to be transferred to the server (120) in a wired way. In this way, noise or disturbances that may arise from wireless communication are prevented. In the said server (120), a noise removal process is performed to reduce the noise generated during the transmission of images to the base station (110) by a processor unit (121). A median filtering process is performed in the said noise removal process in a possible embodiment. An average filtering process is performed in the said noise removal process in a possible embodiment. A block-matching and three-dimensional filtering process are performed in the said noise removal process in a possible embodiment. The image in which the noise removal process is performed is processed through a pre-trained deep learning model in a memory unit (122) of the server (120). The image in which the noise removal process is performed is segmented by a pre-trained deep learning model in a memory unit (122) of the server (120) in a possible embodiment. In another possible embodiment, at least one object is detected in the image in which the noise removal process is performed through a pre-trained deep learning model in a memory unit (122) of the server (120). The said PASCAL visual object classes of the deep learning model are trained with a dataset in a possible embodiment.

The scope of the protection of the invention is set forth in the annexed claims and certainly cannot be limited to exemplary explanations in this detailed description. It is evident that one skilled in the art can make similar embodiments in the light of the explanations above without departing from the main theme of the invention.

What is claimed is:

1. A system comprising:
an air vehicle having an image sensor to acquire images, a control unit to process the images acquired by the image sensor, and a communication unit to transmit the images processed by the control unit to a remote server by at least one base station;
wherein the control unit is configured to modulate the images and send the images to the at least one base station by the communication unit;
the at least one base station is configured to demodulate the images coming from the air vehicle and to transmit the images to the remote server;
the remote server comprises a memory unit containing a pre-trained deep learning model to process the images and a processor unit configured to process the images coming from the air vehicle through the deep learning model in the memory unit; and
the processor unit is configured to perform a noise removal process to reduce noise generated during a transfer of the images to the at least one base station before processing the images acquired by the air vehicle.

2. The system according to claim 1, wherein the remote server comprises the memory unit containing the pre-trained deep learning model to segment the images and the processor unit configured to segment the images coming from the air vehicle through the deep learning model in the memory unit; the processor unit is configured to perform the noise removal process to reduce the noise generated during the transfer of the images to the at least one base station before segmenting the images acquired by the air vehicle.

3. The system according to claim 1, wherein the remote server comprises the memory unit containing the pre-trained deep learning model to detect at least one object in the images and the processor unit configured to detect the at least one object in the images coming from the air vehicle through the deep learning model in the memory unit the processor unit is configured to perform the noise removal process to reduce the noise generated during the transfer of the images to the at least one base station before detecting an object in the images acquired by the air vehicle.

4. The system according to claim 1, wherein the control unit is configured to convert the images into a binary vector.

5. The system according to claim 1, wherein the processor unit is configured to perform median filtering in the noise removal process.

6. The system according to claim 1, wherein the processor unit is configured to perform average filtering in the noise removal process.

7. The system according to claim 1, wherein the processor unit is configured to perform block-matching and three-dimensional filtering in the noise removal process.

8. The system according to claim 1, wherein the deep learning model is trained with the PASCAL visual object classes dataset.

9. The system according to claim 1, wherein the communication unit is a Long Term Evolution (LTE), and the communication unit is configured to demodulate the images acquired by the at least one base station under LTE standards.

10. The system according to claim 1, wherein the communication unit is a 5G module, and the communication unit is configured to demodulate the images acquired by the at least one base station under 5G standards.

11. The system according to claim 1, wherein the air vehicle is an unmanned air vehicle.

12. The system according to claim 11, wherein the unmanned air vehicle is configured to have remote flight control.

13. The system according to claim 11, wherein the unmanned air vehicle is configured to fly along a predetermined route.

14. The system according to claim 11, wherein the unmanned air vehicle is configured to fly autonomously.

15. The system according to claim 1, wherein the image sensor is a camera in such a way that each pixel color is a separate value, and the camera takes a color image recorded with 8 bits for each channel.

16. The system according to claim 1, further comprising a power unit positioned on the air vehicle to provide electrical energy to the air vehicle.

17. The system according to claim 1, wherein the at least one base station is configured to demodulate the images coming from the air vehicle and to transmit the images to the remote server through a cable.

18. A method for processing an image acquired by an air vehicle having an image sensor to acquire the image, and a control unit to process the image acquired by the image sensor, wherein the method comprises the following steps:
acquiring the image through the image sensor,
modulating the image by the control unit to obtain a modulated image for wireless transmission thereof,
transmitting the modulated image to a base station by a communication unit,
demodulating the modulated image transmitted to the base station to obtain a demodulated image,
transmitting the demodulated image to a server through a cable,
performing a noise removal process to reduce noise generated during a transmission of the image to the base station by a processor unit of the server,
processing the image in which the noise removal process is performed through a pre-trained deep learning model in a memory unit of the server.

19. The method according to claim 18, further comprising the step of segmenting the image in which the noise removal process is performed through the pre-trained deep learning model in the memory unit.

20. The method according to claim 18, further comprising the step of detecting at least one object in the image in which the noise removal process is performed through the pre-trained deep learning model in the memory unit.

21-25. (canceled)
